(19) United States
(12) Patent Application Publication
(10) Pub. No.: US 2004/0059796 A1
(43) Pub. Date: Mar. 25, 2004

(54) Method for producing Internet information

(76) Inventor: Graeme McLintock, Konstanz (DE)

Correspondence Address: SIEMENS SCHWEIZ, I-44, INTELLECTUAL PROPERTY, ALBISRIEDERSTRASSE 245, ZURICH, CH-8047, CH

(21) Appl. No.: 10/669,338

(22) Filed: Sep. 25, 2003

Related U.S. Application Data
(63) Continuation of application No. PCT/DE02/01097, filed on Mar. 26, 2002.

(30) Foreign Application Priority Data
Mar. 29, 2001 (DE) 101 15 586.7

(51) Int. Cl. G06F 15/16

(52) U.S. Cl. 709/217

(57) ABSTRACT

The present invention relates to a method by which an end-user can collect and store information form the Internet, in particular from website addresses and can transmit the information to other Internet end-users. The method also allows attribute-based modifications and the addition of information. The invention consists of selecting and packaging stored information that is to be distributed to other end-users. The second end-user can then unpack the received information and process it in the same manner as the first end-user. The desired information that is of interest is stored in a hierarchy determined by the end-user.

### CROSS REFERENCE TO RELATED APPLICATIONS

The present invention is a continuation of international application PCT/DE02/0197, filed on Mar. 26, 2001, which designated the United States and further claims priority to German application 10115586.7, filed on Mar. 29, 2001, both of which are herein incorporated by reference,

### BACKGROUND OF THE INVENTION

This invention relates to the production of Internet information coming from the World Wide Web and to the transmission of this information between end users of the World Wide Web.

The Internet, in particular the World Wide Web, has become the most important source of information in many areas of interest. Whether the Internet user (“end user”) wishes to have deliverable goods which he intends to buy (e.g. audio CDs), nondeliverable goods which he wishes to reserve/buy (e.g. travel tickets, trips) or just information to read (e.g. product manual, newspaper article), everything can be obtained on the Internet.

To make it easier for an end user to refind information once it has been found in the World Wide Web, web browsers provide a bookmark function, which can be used to store web page addresses (i.e. URLs) of interest in a hierarchy determined by the end user. This function is effective for static URLs, such as the URLs for the entry pages for web pages (“homepages”). However, for the addresses of dynamically generated web pages containing details about goods for sale, for example, storing URLs can be very unreliable. This current type of bookmark allows information to be viewed again only online, since only the. URL and not the content of the web page is stored locally. Since most web browsers use a local cache for the web pages, the web pages are available offline at most in part and for a particular period of time.

Current web browsers also allow targeted permanent storage of the content of a displayed web page on the local hard disk, including of any additional files (e.g. images) required. Unfortunately, this function has had no connection to the bookmark function up to now. Web pages which have been stored in this manner cannot always be viewed in the web browser at a later time (i.e. offline) if a plurality of files need to be shown in separate areas of the screen (i.e. frames).

Applications which are based on the interchange of information with a service provider are now widespread on the Internet, e.g. e-shopping. The end user sends information about goods or services which he has downloaded from the service provider's web pages to the service provider as part of an order or job. To collect a plurality of articles to form one order during a plurality of web sessions, Internet vendors provide some kind of shopping cart function.

Particularly for deliverable goods, Internet vendors assist the customer with a web page specific shopping cart function. This web server based function allows the end user to return to the web pages at a later time and to refind his articles selected during an earlier visit. Perhaps the conditions, e.g. availability or price, have changed slightly, but the customer is probably still interested in the previously selected articles.

The sales conditions for nondeliverable goods are very dynamic on account of limited availability and the short-term use deadlines. Airlines, for example, normally do not provide a shopping cart function on their web pages. URLs pointing to web pages with flight information can be very unreliable for later reuse.

Web server based shopping carts are normally limited to the web pages of one vendor. Although attempts have been started to standardize the web servers and either to introduce one shopping cart for a group of vendors, i.e. an e-wallet, or to implement a solution across web pages which involves buffer storing article information on the client computer, i.e. the end user computer, solutions of this type have not yet been implemented on a broad basis.

To implement a shopping cart for a group of vendors, it is necessary for the vendors to work together or for a portal to provide indirect access to the vendors' web pages (U.S. Pat. No. 6,029,141, WO 00/31657). Buffer storing article information on the client computer requires either that the precise article details be additionally downloaded from “compatible” web servers (U.S. Pat. No. 6,125,352, US 5,745,681, US 5,956,709, US 6,134,592) or that the precise article details be “read”, i.e. parsed, from the web page of an arbitrary web server, (U.S. Pat. No. 6,101,482). Parsing a web page in order to find article details presupposes the correct identifiers for the data fields, i.e. “tags”. The tags used by different web servers are not standard, although standardization has been proposed and attempted a number of times. It has also been proposed that said data fields (tags) may be able to be sought manually in a web page (U.S. Pat. No. 5,956,709).

Normally, solutions to date have presupposed either alignments to the web server or assumptions about the content of web pages in order to arrive at the article details, normally an identification code (e.g. ISBN for books), required for an order. This aforementioned precise article information is transmitted from the client to the server for the order, for which purpose the server normally needs to be connected online.

### SUMMARY OF THE INVENTION

The object of the invention is therefore to produce and store information from web pages, which can also be stipulated interactively by end users, such that the web pages can be subsequently viewed offline, that an online connection to the web pages can be set up again easily and reliably, and that the information can be transmitted between the end users.

The invention achieves the object by means of the features of claim 1. Advantageous refinements are presented in the subclaims.

Although an Internet end user can store the content of a browser window in one or more files, it is not always so easy to find the correct files again, and their contents cannot always be shown reliably. This invention makes it easier for the end user to do this by showing the stored web pages in object-based fashion. Each end user action of “marking” or “storing” a web page results in the production of a web object on the hard disk. Each web object can comprise a plurality of downloaded files. The method of this invention involves each web object being in an association with attributes which are stored in a further file. The attributes are identified and stored before, during and after the web object is downloaded and stored.

Each web object is stored such that it can be shown and processed in a web object explorer. The web object explorer is advantageously an extension of the standard web browser, e.g. Netscape Navigator or Microsoft Internet Explorer, and can be implemented in the form of a plug-in, for example.

The end user can use the web object explorer to display and partially edit the attributes stored with each web object.

In this case, it is advantageous to store at least the following information as web object attributes:

A. Segments from the URL of the web page,

A1. Source Internet domain of the downloaded files,

A2. URL of the main web page of the web object,

A3. Text segments which have automatically been identified in the URL of the web page or in addresses for links in the web page,

B. Date and time of downloading,

C. History of the web pages previously visited in the same domain,

D. User inputs in the <INPUT> fields of the web pages,

E. Text segments which have been identified interactively by the user.

A web object's original web page can be shown in the web browser offline and the <INPUT> fields can be edited. User inputs in the <INPUT> fields are stored as attributes of the web object.

The inventive solution allows the service provider to provide his services over the Internet using client-client communication without the need for a web server to process incoming jobs online. Offline communication, e.g. e-mail, and the web server with static web pages should suffice for providing services and for receiving jobs, the jobs being able to be processed effectively using the method of this invention.

The web object explorer allows the user not just to select web objects for display and editing but also to organize the web objects in packets (“web packets”). The web packets can in turn be associated with attributes. A web packet can be compressed into a file and can be distributed further using the web object explorer, e.g. by e-mail or by http to a web server. A web packet can also be extended by additional information, i.e. further attributes which are added interactively by the end user or automatically. In this context, the web objects can be reduced in order to restrict the web packet size, e.g. transmission without images, or transmission of the web object attributes only.

Anyone possessing the required knowledge will be able to see that the transmission of web pages collected and processed using the method of this invention between Internet client computers can serve as the basis for implementing various applications. By way of example, forwarding web pages collected in this manner to a vendor together with payment information can serve as the basis for e-business. Such a vendor would not need to have the desired article in his product catalog. The web pages have been downloaded from an arbitrary web server. The vendor could always look up precisely which article is required in the original web pages and specified attributes (e.g. color or number of items) sent at the same time.

This method permits new types of Internet vendors and services, for example:

gathering a plurality of deliveries from various suppliers into one delivery.

delivering inexpensive articles from stock if available, but imported articles otherwise.

delivering inexpensive imports, with a vendor himself finding a source.

providing a reliable purchase opportunity using trusted business conditions which are known to the customer so that the customer can shop without the risk of devious business conditions,

cheap entry opportunity for vendors who do not want to use an expensive online web server and who accept orders by e-mail.

If an end user receives a file in which a web packet is packed, he can unpack this web packet and add it to the others on the hard disk. The end user can then process the received web packet further, as the sending end user did.

### BRIEF DESCRIPTION OF THE SEVERAL VIEWS OF THE DRAWINGS

The novel features believed characteristic of the invention are set out in the claims below. The invention itself, however, as well as other features and advantages thereof, are best understood by reference to the detailed description, which follows, when read in conjunction with the accompanying drawing, wherein:

FIG. 1 shows the transmission of web pages from the web server to the web client;

FIG. 2 shows a flowchart showing the storage of a web page on the hard disk;

FIG. 3 shows a flowchart showing the production of an attribute by editing an INPUT field;

FIG. 4 shows a flowchart showing the production of an attribute by interactively marking text segments;

FIG. 5 shows a flowchart showing the production of an attribute by identifying text segments in the URL;

FIG. 6 shows a flowchart showing the production of an attribute by identifying text segments in a web page's link;

FIG. 7 shows one possible appearance for the web object explorer;

FIG. 8 shows a flowchart showing the production of a web packet file for further distribution;

FIG. 9 shows a flowchart showing the unpacking of a received web packet file.

### DETAILED DESCRIPTION OF THE INVENTION

In one possible implementation of this invention, the functionality of a standard web browser is complemented by the web object explorer by means of a plug-in. The plug-in needs to have been installed on the client computer in order to make the functions of the web object explorer available. Other implementations could extend the web browser in other ways in order to provide the same functionality, e.g. by controlling the web browser using a COM or other interface.

The end user has access to the functionality of the web object explorer through a further window in the user interface, which window is either constantly visible next to the web browser or is shown as an icon for the first time and can be opened when required using the mouse or the keyboard. Other implementations could provide a special web browser having an integrated web object explorer.

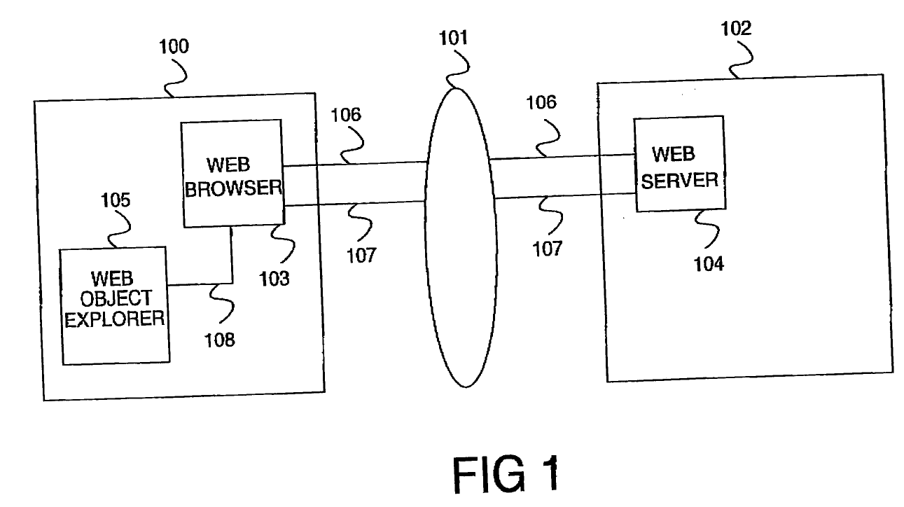

FIG. 1 shows how a web page is downloaded by the client computer 100 from the server computer 102 via the Internet 101 when required by the end user. Any web page is requested by the web browser 103 using an HTTP GET message 106. The web server 104 responds to every request message with an HTTP message 107, which contains the desired web page. Every completed transmission of a web page results in a message 108 which is sent to a previously installed web object explorer 105 registered for this purpose. These messages 108 result in the web object explorer 105 tracking the sequence of the web pages downloaded from every domain.

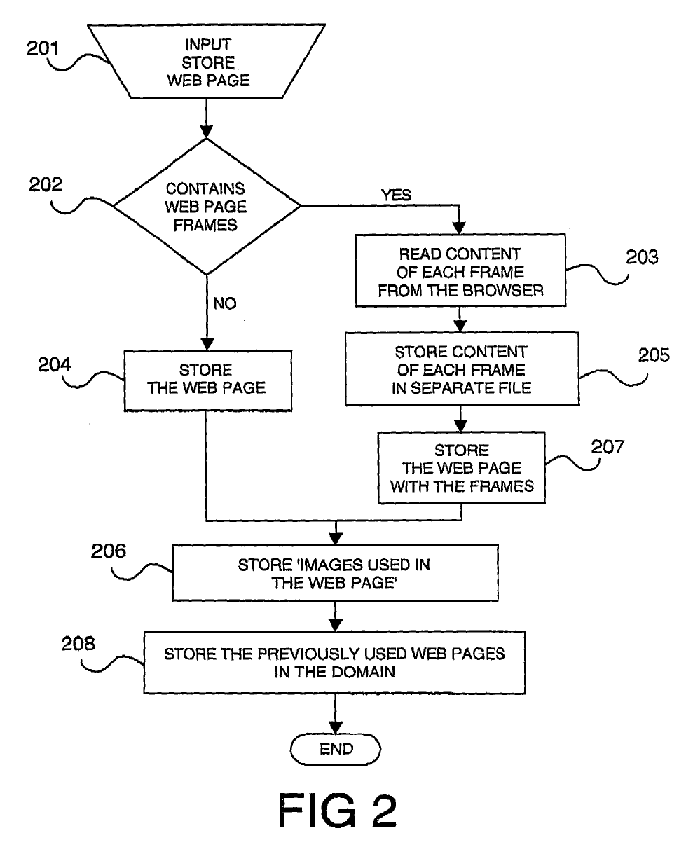

If an end user is interested in a web page, he can use a mouse or a keyboard entry to “mark” the web page (i.e. to set bookmarks) and to “store” it using the user interface in the web object explorer 105. The web object explorer 105 then produces a web object on the hard disk on the client computer and stores the web page as shown in FIG. 2. Following the end user entry for storing the web page 201, the web object explorer checks the web page 202 and establishes whether it is using frames. Should the web page 202 contain no frames, it is simply stored 204 on the hard disk. For this, the HTML content of the web page 202 is read from the web browser and is stored in a file; a second file “web object file” stores the aforementioned attributes A1, A2 and B associated with the web object. Should the web page 202 actually contain frames, the content of every frame needs to be read 203 from the browser and stored 205 in a separate file. Next, the web page in which the frames are described needs to be stored 207, with the references to the files with the frame contents being transcribed on the separate files 205, Should images be used in any of the stored files, i.e. frames, these additionally need to be stored 206. In the preferred implementation of this invention, the images are only stored as well if the web object explorer 105 has the appropriate configuration. Nevertheless, the images could be seen later in the stored web pages, since these often use reliable URLs, even in dynamically created web pages, and can be downloaded online. At any rate, the stored web pages can also be shown without images. After that, attributes of type C are stored 208.

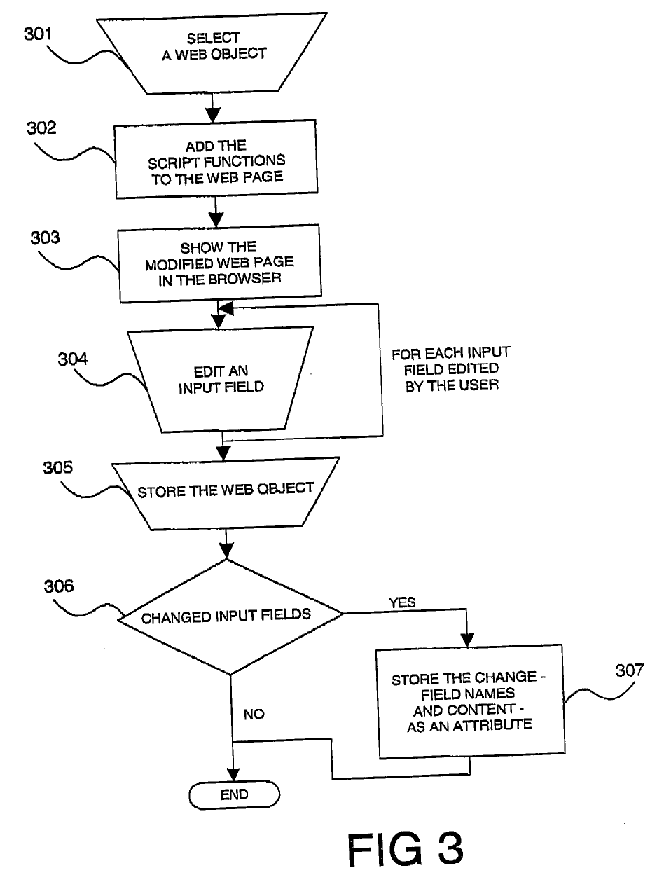

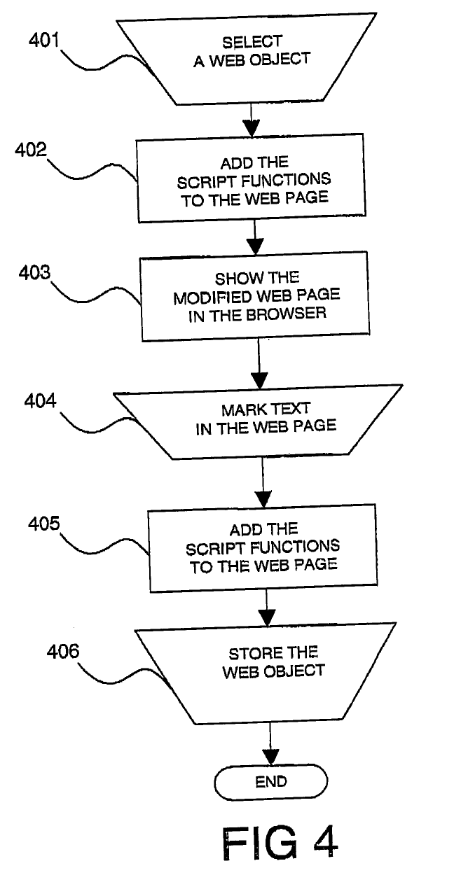

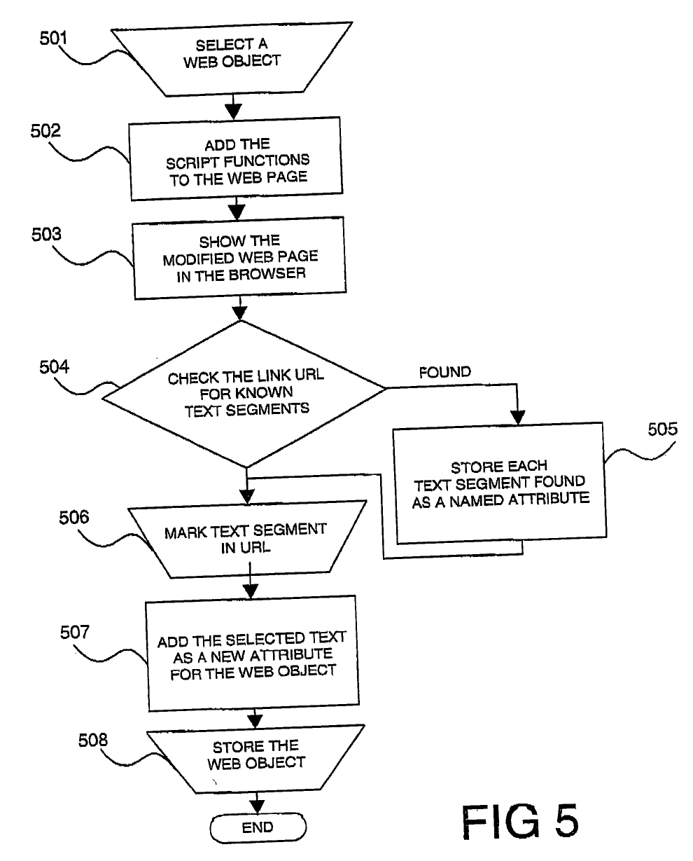

The end user can store additional attributes with a web object. These can be produced using <INPUT> fields or links in the web page, or from the web page's URL. First, the web object needs to be selected using the user interface in the web object explorer 105, and it then needs to be processed as described in FIG. 3, FIG. 4 and FIG. 5.

FIG. 3 shows a flowchart of the steps in producing an attribute based on an <INPUT> field on the web page. First, the end user chooses the correct web object 301. The associated web page is read from the hard disk and is complemented 302 by a few script functions. The modified web page is then shown 303 in the web browser. The end user can now edit 304 any desired <INPUT> fields in the web page, the user inputs being recorded by the script functions 302. After that, the end user can store 305 the changes using the user interface in the web object explorer 105. During storage, the web object explorer 105 checks whether there are changes 306 and stores these changes as NAME=VALUE attributes in the web object file 307, the NAME being obtained from the tag name of the edited <INPUT> fields.

FIG. 4 shows a flowchart of the steps when producing an attribute based on an arbitrary text segment from the web page. First, the end user chooses the correct web object 401. The associated web page is read from the hard disk and is complemented 402 by a few script functions. The modified web page is then shown 403 in the web browser. The end user can now use the mouse or the keyboard to select 404 any desired text segment. The selected text is copied 405 to the web object explorer 105 window by the end user using cut & paste, drag & drop or a function key. The copied text is stored by the web object explorer 105 as a new attribute, and the end user can give the attribute a name either at this time or at a later time. The end user can then prompt 406 storage of the web object with the new attributes in the web object file using the web object explorer 105.

FIG. 5 shows a flowchart of the steps when producing an attribute generated from the web page's URL. First, the end user chooses the correct web object 501. The associated web page is read from the hard disk and is complemented 502 by a few script functions. The modified web page is then shown 503 in the web browser. The web page's URL is automatically checked 504 by the web object explorer 105 in order to identify known text segments, which are defined in a configuration file. In the preferred implementation, the configuration file is read by the web object explorer 105 after the start and after the file has been changed. In this way, the web object explorer 105 is configured with a plurality of attribute templates, comprising text patterns (“regular expressions”) and the appropriate attribute names.

Text segments identified in the URL are stored 505 as named attributes (NAME=VALUE). The end user can additionally select 506 a text segment of the URL interactively using the mouse and can copy this text, as described above for 405, to the web object explorer 105 in order to create 507 a further attribute. The end user can then prompt 508 storage of the web object with the new attributes in the web object file using the web object explorer 105.

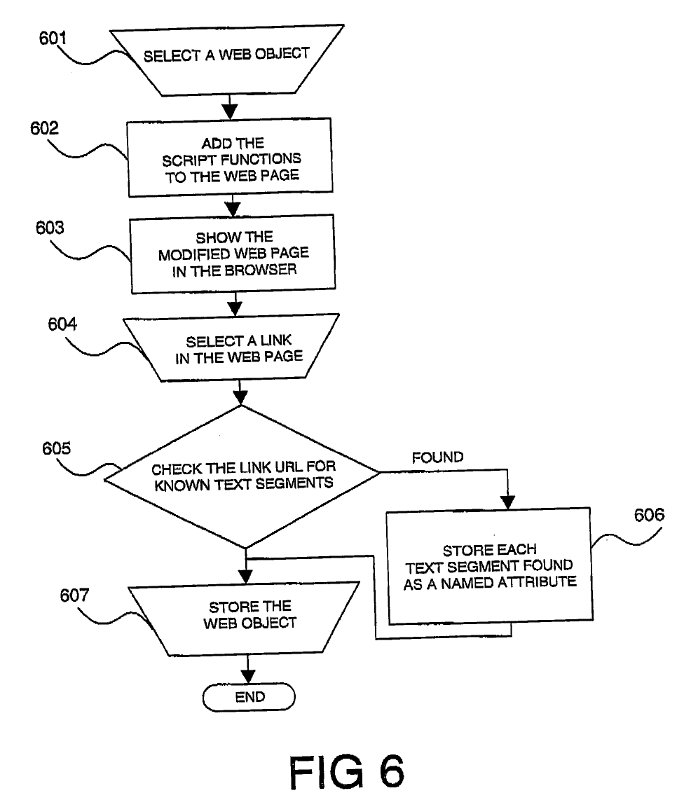

FIG. 6 shows a flowchart of the steps when producing an attribute generated from the URL of a link shown in the web page. First, the end user chooses the correct web object 601. The associated web page is read from the hard disk and is complemented 602 by a few script functions. The modified web page is then shown 603 in the web browser. The end user can now click on and select a link in the web page, Normally, the web browser would follow the link and would request the appropriate web page, as shown in FIG. 1. The end user can use the web object explorer 105 to change this behavior by creating attributes instead. In this case, the web object explorer 105 processes the selected link and examines the URL of the link 605 as described above for 504. Should text segments be identified in the link's URL, they are stored 606 as newly named attributes (NAME=VALUE). The end user can select further links and finally can prompt 607 storage of the web object with the new attributes in the web object file using the web object explorer 105.

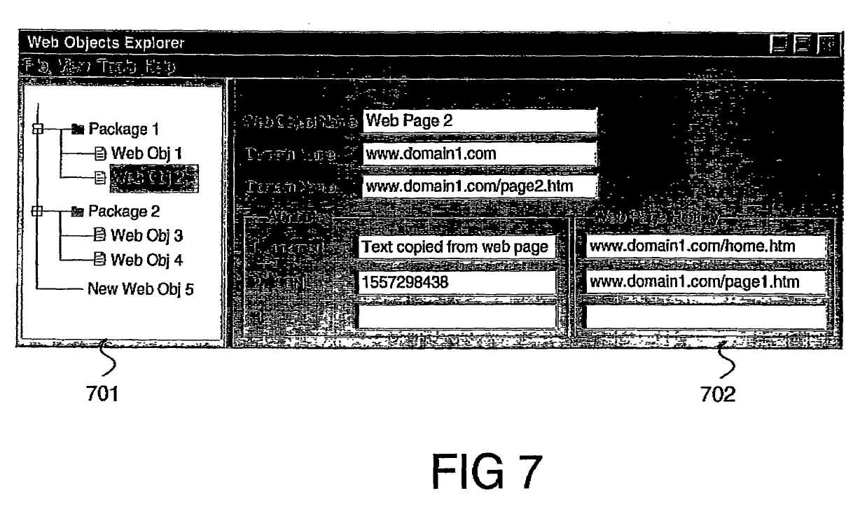

FIG. 7 shows one possible appearance for the user interface in the web object explorer 105. The user interface is split into two windows. The first window 701 shows a tree-like representation of the web packets and web objects stored on the hard disk. The other window 702 shows detailed information associated with the web object or web packet which is currently selected in the tree representation. The information shown for a web object is at least:

A. Source Internet domain of the downloaded files.

B. Date and time of downloading.

C. URL of the main web page of the web object.

D. History of the web pages previously visited in the same domain.

E. All attributes associated with the web object.

The information shown for a web packet is at least:

A. File name for the packed web objects.

B. Checking statements for the packing of the web objects.

C. All attributes associated with the web packet.

The web object explorer 105 produces the file name A of the web packet at the instant at which the end user first creates the web packet, but it can be changed by the end user at any time. The checking statements B check how and which file types (e.g. images) need to be packed into the web packet. The end user can associate attributes C with the web packet by interactively defining these attributes as described above for web objects. For this, the end user can simultaneously see a web object's web page in the web browser and handle the web packet in the web object explorer 105.

In one application of this invention, the web packet attributes can be used in order to send a notice or payment information to the receiver of a web packet. When the end user has produced a web packet, he can add existing web objects to the web packet using drag & drop in the tree representation.

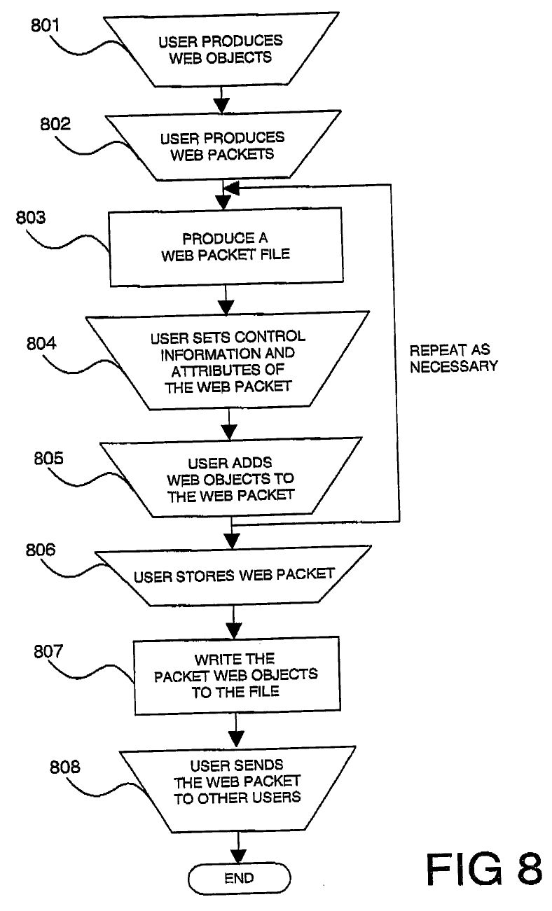

FIG. 8 shows a flowchart of the steps when producing a packet of web objects. First, the end user needs to produce 801 the web objects which are to be packed (see FIG. 2). Next, the end user produces a web packet using the user interface in the web object explorer 802. The web object explorer produces a web packet file 803 by storing the checking information and attributes of the web packet, and also the packed web objects. In the preferred implementation, step 803 results in a web packet node being produced in the tree representation 701. The end user can then use the web object explorer 105 to change the web packet file name and the checking information, and also to produce and change 804 web packet attributes. The end user can also add 805 web objects to the web packet, as described above. Steps 804 and 805 can be repeated and the web objects can be checked until the end user is satisfied with the web packet content. The end user then stores the web packet 806, with the web object explorer writing 807 the web packet content to the web packet file. The end user can then transmit 808 the web packet file to others, with any standard method for file transmission being suitable for this, e.g. e-mail attachment, or can send it to a web server using FTP or http.

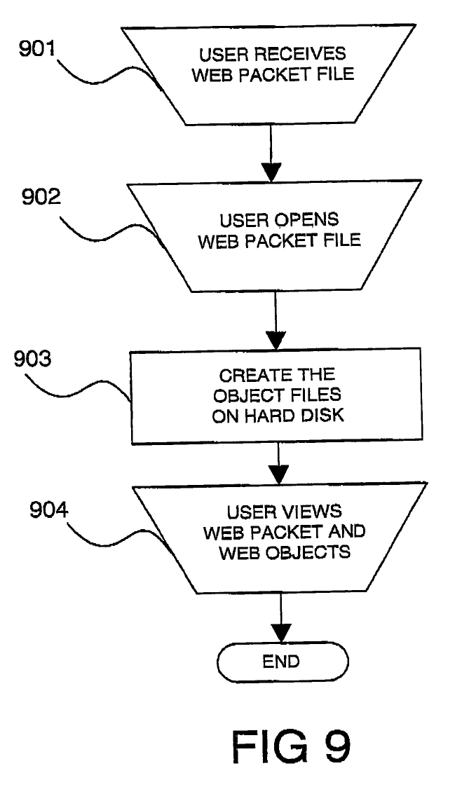

FIG. 9 shows a flowchart of the steps when unpacking a received web packet file, First, the end user receives the web packet file 901 by means of an arbitrary method of file transmission, e.g. by e-mail. The end user can open the web packet file immediately, can store it on the hard disk first and can open it later, or can drop it 902 onto the web object explorer 105 using drag & drop. The web object explorer 105 then imports the file 903 and creates the web object files packed into the file on the hard disk. The end user can then view 904 the web packet and the web objects, as did the sending end user. The end user can view not just the received web pages offline, but can also easily return to the URL of any web page online (if these are accessible to him). It is more reliable and an important feature of this invention for a transmittable URL to be compiled from the domain name and from the automatically or manually identified text segments of the web page's URL. The way in which such transmittable URLs are compiled has a similar configuration to text segment identification. The end user can also return to the other web pages in the web page history of the web object if the history has also been transmitted. Naturally, the user can use the received web objects, or the altered copies thereof, in new web packets.

What is claimed is:

1. A method for producing Internet information, wherein an end user unit generates one or more segments from the address (URL) of a downloaded web page as one or more attributes and stores them in a web object.

2. The method as claimed in claim 1, in that the downloaded web page in the end user unit produces further attributes and stores them in the web object.

3. The method as claimed in claim 1, wherein, in addition to the attributes, the associated web pages or selected parts thereof are stored in the web object.

4. The method as claimed in claim 2, wherein the date and time when the web page was downloaded are entered as a further attribute for the web page.

5. The method as claimed in claim 2, wherein a list of the web pages previously visited in the same domain is entered as a further attribute for the web page.

6. The method as claimed in claim 2, wherein end user inputs into “input” fields on the web page are entered as further attributes for the web page.

7. The method as claimed in claim 2, wherein segments from addresses for links in the web page are entered as further attributes for the web page.

8. The method as claimed in claim 1, wherein the segments from the addresses are chosen such that reliable means of access to the web pages are obtained.

9. The method as claimed in claim 2, wherein remark texts are entered as further attributes.

10. The method as claimed in claim 1, wherein the attribute or attributes of the respective web page are transmitted to one or more further end users of the Internet.

11. The method as claimed in claim 10, wherein in addition to the attributes, the associated downloaded web page or the selected parts thereof are transmitted.

12. The method as claimed in claim 1, wherein the attributes are automatically generated from addresses (URL) by using the respective address to search a configuration file and, if a segment of the address is found in the configuration file, by assigning this part as a sought attribute from the address of the web page.

13. The method as claimed in claim 12, wherein the configuration file contains attribute templates, comprising text patterns and appropriate attribute names.

14. The method as claimed in claim 13, wherein the segments found are stored as named attributes (NAME=VALUE).

15. The method as claimed in one of claim 1, wherein a plurality of web objects are combined to form a web packet.

16. The method as claimed in claim 15, wherein a web packet is assigned one or more additional attributes.

17. The method as claimed in claim 15, wherein a web packet is combined with the associated additional attributes to form a packet file.

18. The method as claimed in claim 17, wherein the packet file is transmitted as a whole or in selected parts to further end users.

19. The method as claimed in claim 1, wherein a web object explorer is used to display the attributes in the end user unit, to process them and to combine the web objects to form web packets and to transmit them.

20. The method as claimed in claim 19, wherein the web object explorer is implemented as a plug-in, in order to extend a standard web browser.

21. The method as claimed in claim 10, wherein transmission is effected in the form of e-mail.

22. The method as claimed in claim 10, wherein transmission is effected via a web server using HTTP.
